(19) United States
(12) Patent Application Publication
(10) Pub. No.: US 2026/0332241 A1
(43) Pub. Date: Oct. 22, 2026

(54) MOBILE SATELLITE BEAM DECONFLICTION

(71) Applicant: Viasat, Inc., Carlsbad, CA (US)

(72) Inventors: Nicholas G. BERNDSEN, Parker, CO (US); James E. PETRANOVICH, La Jolla, CA (US); Brian T. SLEIGHT, Carlsbad, CA (US); Michail K. TSATSANIS, Huntington Beach, CA (US); Anton HOFFMAN, San Diego, CA (US)

(21) Appl. No.: 19/121,760

(22) PCT Filed: Oct. 18, 2022
(86) PCT No.: PCT/US2022/047061

§ 371 Date: Apr. 16, 2025

(51) Int. Cl. H04B 7/185; H04B 7/06; H04B 17/345

(52) U.S. Cl. CPC H04B 7/18513; H04B 7/0617; H04B 7/18519; H04B 17/345

(57) ABSTRACT

Methods, systems, and devices for mobile satellite beam deconfliction are described. A communication service may be provided to mobile terminals via respective beamformed spot beams that track movement of the mobile terminals. When a conflict arises between two beams, one of the beams may be switched to another resource to continue providing the communication service to its associated mobile terminal without performing a beam-to-beam handoff, thereby avoiding performance degradation and disruptions associated with handoffs.

### CROSS REFERENCE

The present Application is a 371 national phase filing of International Patent Application No. PCT/US2022/047061 by BERNDSEN et al. entitled, “MOBILE SATELLITE BEAM DECONFLICTION”, filed Oct. 18, 2022, which is assigned to the assignee hereof and which is hereby incorporated by reference in its entirety.

### FIELD OF TECHNOLOGY

The following relates generally to communications, including mobile satellite beam deconfliction.

### BACKGROUND

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, and an amount of frequency reuse within the region in which service is provided. Satellite communications may use beamforming to establish beams to increase frequency reuse, however, providing a high level of frequency reuse in satellite communication systems employing beamforming presents challenges.

### SUMMARY

The described techniques relate to improved methods, systems, devices, and apparatuses that support mobile satellite beam deconfliction. For example, a communication service may be provided to mobile terminals via respective beamformed spot beams that track movement of the mobile terminals. When a conflict arises between two beams, one of the beams may be switched to another resource such that the communication service may continue to be provided to the associated mobile terminals via the respective beamformed spot beams without a beam-to-beam handoff being performed, thereby avoiding performance degradation and disruptions associated with handoffs.

### BRIEF DESCRIPTION OF THE DRAWINGS

FIG. 1 shows an example of a satellite communication system that supports mobile satellite beam deconfliction in accordance with examples described herein.

FIGS. 2A and 2B show examples of resources for a satellite communication system that supports mobile satellite beam deconfliction in accordance with examples described herein.

FIG. 3 illustrates an example of a satellite communication system that supports mobile satellite beam deconfliction in accordance with examples as disclosed herein.

FIG. 4 illustrates an example of another satellite communication system that supports mobile satellite beam deconfliction in accordance with examples as disclosed herein.

FIG. 5 illustrates an example timing diagram that supports mobile satellite beam deconfliction in accordance with examples as disclosed herein.

FIG. 6 shows a block diagram of a beam manager that supports mobile satellite beam deconfliction in accordance with examples as disclosed herein.

FIG. 7 shows a block diagram of a terminal tracker that supports mobile satellite beam deconfliction in accordance with examples as disclosed herein.

FIG. 8 shows a flowchart illustrating a method that supports mobile satellite beam deconfliction in accordance with examples as disclosed herein.

### DETAILED DESCRIPTION

Beam-to-beam handoffs of mobile terminals can be a source of disruption to end-users due to lost or delayed packets or a change in beam congestion levels or capabilities. In some satellite communication systems, beam-to-beam handoffs of mobile terminals may be based on relative locations of the mobile terminals within adjacent fixed beams, which may not consider interference between beams. For example, the handoff may occur when the mobile terminal is within overlapping portions on the edges of the coverage areas of adjacent beams. At these locations, the mobile terminal may have a low signal-to-noise ratio (SNR) (e.g., when compared to the mobile terminal being at the center of the coverage area), resulting in performance degradation. To compensate, a lower coding rate may be instituted that provides more redundancy. However, this reduces the overall communication speed and is inefficient. Further, all of the edge portions of a coverage area of a beam must overlap with at least one of the other beams, requiring wide beams and significant beam overlap.

For mobile terminals on slow moving vehicles, such as automobiles or ships, handoffs may occur relatively infrequently, and the ensuing performance degradation and disruptions may have little overall effect on communications associated with the mobile terminals. But for mobile terminals on fast moving vehicles, such as aircraft, the performance degradation and disruptions caused by frequent beam-to-beam handoffs may occur relatively frequently so as to have a much greater effect on the communications. Either way, reducing the number of beam-to-beam handoffs to reduce the ensuing performance degradation and number of disruptions may be beneficial.

Techniques are described for performing beam deconfliction between beamformed spot beams that track individual mobile terminals while communication service is provided to the mobile terminals via the beamformed spot beams. The deconfliction may be performed, e.g., instead of beam-to-beam handoffs of the mobile terminals and may be based on conflicts (e.g., interference) between the beams. In some cases, beam deconfliction may be initiated when an interference level between beams satisfies a threshold value (e.g., meets; or exceeds; or meets or exceeds the threshold value). By doing this instead of performing beam-to-beam handoffs, the frequency and number of beam-to-beam handoffs associated with the mobile terminals may be reduced, which may reduce the overall amount of performance degradation and number of disruptions caused by handoffs. This may be especially beneficial for mobile terminals on fast moving vehicles (e.g., aircraft). In addition, narrower beams may be used with individual mobile terminals than with current systems, allowing more beams to be used, which may increase overall capacity via spectrum reuse.

Aspects of the disclosure are initially described in the context of satellite communication systems. Aspects of the disclosure are further illustrated by and described with reference to apparatus diagrams, system diagrams, block diagrams, and flowcharts that relate to mobile satellite beam deconfliction.

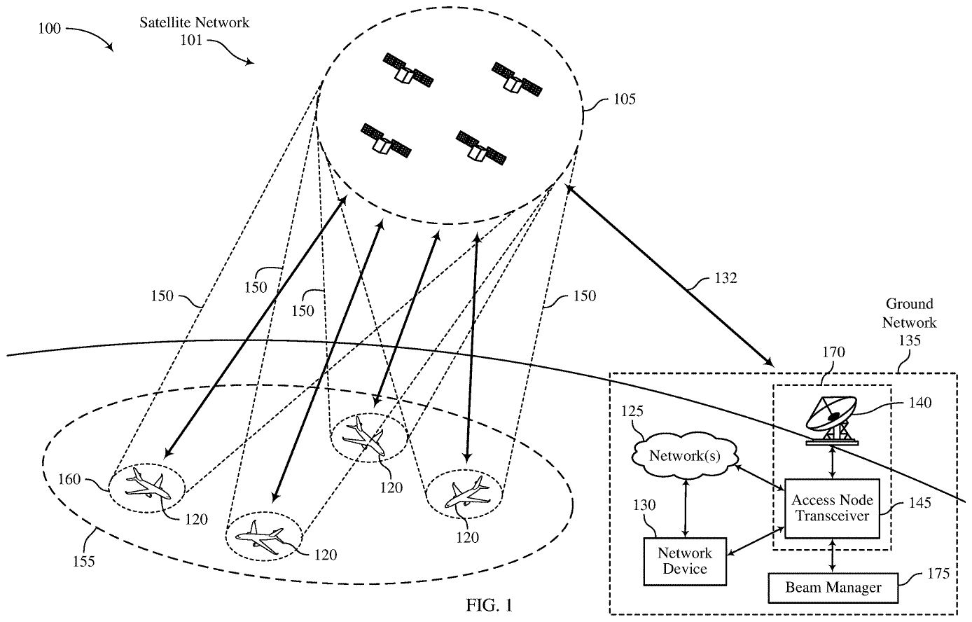

FIG. 1 shows an example of a satellite communication system 100 that supports mobile satellite beam deconfliction in accordance with examples described herein. Satellite communication system 100 may include a ground network 135 and a satellite network 101 configured to track and provide communication service to one or more mobile terminals 120.

The ground network 135 may include a collection of earth stations 170 having access nodes 140 configured to communicate with the satellite network 101 via a feeder link 132 (e.g., one or more satellite beams). The access nodes 140 may be coupled with access node transceivers 145 that are configured to process signals received from and to be transmitted through corresponding access node(s) 140. The access node transceivers 145 may also be configured to interface with a network 125 (e.g., the Internet) e.g., via a network device 130 (e.g., a network operations center, satellite and gateway terminal command centers, or other central processing centers or devices) that may provide an interface for communicating with the network 125.

The ground network may also include a beam manager 175 for tracking mobile terminals 120 as communication service is provided to the terminals. Beam manager 175 may use reference-terminal associated beamformed spot beams, as discussed herein. For example, tracking of mobile terminals and performing deconfliction between associated beams, discussed herein may be controlled by beam manager 175 using the beams. Beam manager 175 may retrieve information (e.g., associated with the satellite network 101 and the terminals 120) from the satellite network 101 (e.g., via feeder link 132 and an access node 140) for performing the controlling, and may send commands (e.g., to the satellite network 101 and/or the terminals 120) accordingly (e.g., via the access node and feeder link).

Although depicted herein as a single device, beam manager 175 may alternatively be distributed throughout the system, e.g., in various elements of the satellite network and/or the ground network. For example, beam manager 175 may be incorporated into one or more devices of the ground network (e.g., a network device 130 or an access node transceiver 145), or one or more devices of the satellite network (e.g., in a single satellite 105 or distributed among multiple satellites), or a combination of devices in the ground network and the satellite network. In some embodiments, a first portion of beam manager 175 may be located in ground network 135 and a second portion may be located in satellite network 101.

Terminals 120 may include various devices configured to communicate signals with the satellite network 101. Although terminals 120 are illustrated as being on aircraft, terminals 120 may include fixed terminals (e.g., ground-based stationary terminals) or mobile terminals mounted on mobile platforms (e.g., boats, aircraft, ground-based vehicles, and the like), or a combination of fixed and mobile terminals. A terminal 120 may communicate data and information with an access node 140 via the satellite network 101. The data and information may be communicated with a destination device such as a network device 130, or some other device or distributed server associated with a network 125.

Satellite network 101 may include one or more satellites 105 (e.g., a single satellite or a network of satellites) that are deployed in space orbits (e.g., low earth orbits, medium earth orbits, geosynchronous orbits, geostationary orbits, etc.). Each satellite 105 included in satellite network 101 may be equipped with one or more antennas (e.g., a single antenna or an antenna array). In some examples, the one or more satellites 105 equipped with multiple antennas may each include one or more antenna panels that include an array of evenly distributed antennas (which may also be referred to as antenna elements). In some examples, a satellite may be equipped with an antenna array including antennas that are unevenly distributed across a large region. The ground network 135 may also contain access nodes 140 with multiple antenna array elements.

Terminals 120 may include an antenna assembly which may also include various hardware for mounting an antenna. An antenna assembly may also include circuits and/or processors for converting (e.g., performing frequency conversion, modulating/demodulating, multiplexing/demultiplexing, filtering, forwarding, etc.) between radio frequency (RF) satellite communication signals, and satellite terminal communications signals transmitted between the antenna and a satellite terminal receiver. For mobile terminals, the antenna assembly may be mounted on the outside of the mobile platform (e.g., outside of the fuselage of an aircraft). Additionally, or alternatively, the terminal 120 may include a transceiver, which may be mounted on the inside or outside of the mobile platform and may include circuits and/or processors for performing various RF signal operations (e.g., receiving, performing frequency conversion, modulating/demodulating, multiplexing/demultiplexing, etc.).

The satellite network 101 may have a large aperture size, which may be spanned by the antenna arrays or multiple satellites of the satellite network 101. Beam manager 175 may use the one or more satellites to support beamforming techniques within the coverage area 155 of the satellite communication system to increase a utilization of resources used for communications. Beam manager 175 may employ beamforming, including using multiple-input multiple-output (MIMO) techniques, to exploit multipath signal propagation and increase spectral efficiency by transmitting or receiving multiple signals via different spatial layers over the same frequency resources. Beam manager 175 may cause multiple signals, for example, to be transmitted by a transmitting device (e.g., a satellite 105) via a set of antennas in accordance with a set of weighting coefficients. Likewise, the multiple signals may be received by a receiving device (e.g., a terminal 120) via a set of antennas in accordance with a set of weighting coefficients. Each of the multiple signals may be associated with a separate spatial stream and may carry bits associated with the same data stream (e.g., the same codeword) or different data streams (e.g., different codewords).

In some examples, some or all of the antenna elements on the satellites 105, the ground network 135, and/or the terminals 120 may be arranged as an array of constituent receive and/or transmit feed elements that cooperate to enable various examples of on-board beamforming (OBBF), ground-based beamforming (GBBF), end-to-end beamforming, or other types of beamforming. In the GBBF implementation, there may be multiple transmit or receive antennas on the ground system access node(s).

Beam manager 175 may determine weighting coefficients to apply to the set of antennas. For example, for N spatial layers to be formed, beam manager 175 may utilize an (M×N) MIMO matrix, where M may represent the quantity of antennas of the set of antennas. In some examples, M may be equal to N. Beam manager 175 may determine the MIMO matrix based on a channel matrix and may use the MIMO matrix to isolate the different spatial layers of the channel. In some examples, beam manager 175 may select the weighting coefficients to emphasize signals transmitted using the different spatial layers while reducing interference of signals transmitted in the other spatial layers. Accordingly, processing signals received at each antenna of the set of antennas (e.g., a signal received at the set of antennas) using the MIMO matrix may result in multiple signals being output, where each of the multiple signals may correspond to one of the spatial layers. In some examples, the weighting coefficients used for MIMO communications may be referred to as beam coefficients or beamforming coefficients, and the multiple spatial layers may be referred to as beams or spot beams.

Beam manager 175 may determine the elements of the MIMO matrix used to form the spatial layers of the channel based on channel sounding probes. Channel sounding probes may include reference signals transmitted periodically between satellite network 101 and a device (e.g., a terminal 120) coupled with the satellite network. For example, a channel sounding probe may be periodically transmitted from a terminal 120 to a satellite 105, or from the satellite to the terminal, or both, and may include a sequence that is known to the transmitter and receiver (e.g., based on a terminal identifier or other parameters known to the transmitter and receiver). The receiving device (e.g., the terminal or the satellite) may use the received channel sounding probe to evaluate the connection by correlating the received channel sounding probe to the expected signal for the channel sounding probe (e.g., to determine a signal strength, an interference, etc.) and make decisions based thereon. Due to the periodicity of the signal, the receiving device may know when the signal should be received.

Beam manager 175 may use beamforming techniques to shape or steer a communication beam along a spatial path between one or more satellites and a mobile terminal 120 within a geographic area. Beam manager 175 may cause a communication beam to be formed by determining weighting coefficients for antenna elements of an antenna array that result in the signals transmitted from or received at the antenna elements being combined such that signals propagating in a particular orientation with respect to an antenna array experience constructive interference while others experience destructive interference. Thus, beamforming may be used to transmit signals having energy that is focused in a direction of a communication beam and to receive signals that arrive in a direction of the communication with increased signal power (relative to the absence of beamforming). Beam manager 175 may use the weighting coefficients to apply amplitude offsets, phase offsets, or both to signals carried via the antennas.

In some examples, beam manager 175 may apply the weighting coefficients to the antennas to form multiple beams, each associated with a different direction, where the multiple beams may be used to communicate multiple signals having the same frequency at the same time to different user terminals. This may be referred to as Multiuser MIMO. The weighting coefficients used for beamforming may be referred to as beam coefficients, and the multiple signals may be referred to as beam signals. The resulting beams may be referred to herein as beamformed spot beams, spot beams, or beams.

Beam manager 175 may calculate the amplitude and phase of each weighting coefficient given the antenna array and reflector geometry and location and the desired beam locations. However, due to inaccuracies (e.g., in the satellite locations, array orientation, geometry, atmospheric scintillation effects, etc.), such an approach may be impractical. Instead, beam manager 175 may calculate the weighting coefficients using continuous or periodic measurements of the MIMO propagation channel characteristics (e.g., pairwise channels from each system antenna element to each terminal antenna element) and adjusting the weighting coefficients based on the changing channel characteristics. The measured MIMO channel characteristics may include pairwise gain and phase response and noise level and may be referred to as MIMO channel state information (CSI). Once the MIMO CSI is available, beam manager 175 may derive the weighting coefficients by solving a set of equations or applying a set of adaptation formulas. Various beamformer calculation and adaptation techniques may be used, including minimum mean square (MMSE) beamformer, zero forcing beamformer, MIMO sphere decoder, and others.

The measurement of MIMO CSI may include the collaboration of at least one terminal for each beam. The situation may be different for the forward link direction (from the satellites to the terminals) versus the return link direction (from the terminals to the satellites). In the return link, each terminal may transmit a channel probing signal that may be orthogonal to probing signals of the other terminals. The satellites may determine which channel probing signal is transmitted from each terminal and may process the signal to estimate the channel parameters of the channel corresponding to that terminal. As such, the MIMO CSI on the return link may be computed locally on the satellite side for terminals that transmit channel probing signals. In contrast, on the forward link, the satellites may transmit channel probing signals. Different antenna elements may transmit signals that are orthogonal to each other. Each terminal tasked to compute MIMO CSI may do so by processing the probing signal corresponding to each transmit antenna element. Further, each such terminal may transmit the MIMO CSI back to a satellite using a return link control channel.

The spot beams generated that way may be tailored to the MIMO CSI provided by the user terminals and each beam may illuminate the direction of each such terminal. Each beam has a finite coverage area 160 (e.g., several km diameter) and may therefore illuminate additional terminals that may be in the vicinity of the CSI generating terminal. These additional terminals may not provide CSI, as this may unnecessarily increase the CSI reporting channel overhead. The terminal that is used to provide MIMO CSI per beam may be considered the reference terminal for that beam. In some examples, the coverage area 160 of a beam may be determined based on the wavelength of the carrier wave and the diameter of the aperture. The coverage area 160 may correspond, e.g., to a footprint where the power level of the beam is above a threshold, or where the power level drop-off away from the center of the beam is less than a threshold amount (e.g., 3 decibels (dB) or 6 dB). In some examples, the coverage area 160 may be based on a beam width of the beam.

In some examples, one or more aircraft-based terminals 120 may be sufficiently separated in distance from each other and from the other aircraft, so that beam manager 605 may use a separate beam for each of the one or more terminals. In some examples, two or more of the terminals 120 may be in close proximity (e.g., at an airport) such that beam manager 605 may illuminate the terminals by a same beam. In the former case, each terminal on an aircraft may be a reference terminal for its beam, while in the latter case, one of several terminals on aircraft may serve as a reference terminal for the beam.

As the mobile terminal 120 moves in the airspace, the MIMO CSI may change, causing the direction of the beam to change. Beam manager 175 may adjust the beam direction based on the changed MIMO CSI so that the reference terminal may remain at or near the center of the beam. Therefore, as the reference terminal moves, the beam may follow its movement, as further explained herein.

Beam manager 175 may associate the beamformed spot beams with a set of resources of the satellite communication system 100. The set of resources may include, e.g., frequency resources, time resources, and polarization resources. For example, a given frequency range for the satellite communication system 100 may comprise frequency resources or channels, and a given amount of time may comprise different recurring time slots. For example, beam manager 175 may use a frequency channel to carry a signal (e.g., a modulated signal carried in a beamformed spot beam) on one of the recurring time slots. By doing this, beamformed spot beams may overlap spatially without interfering if they are associated with different frequency/time resource combinations. In addition, beam manager 175 may use multiple polarizations such that two beamformed spot beams may overlap spatially without interfering if they are associated with different polarizations. Thus, beamformed spot beams may overlap spatially without interfering if they are associated with different combinations of the resources (e.g., frequency channel/time slot/polarization combinations). The different combinations may be known as resource elements that together form a set of resource elements that may be used by beam manager 175 for communicating signals over a beam. Beam manager 175 may control the association of the beams with the resource elements and when to reassign the beams, as discussed herein.

As discussed herein, beam manager 175 may adjust the individual coverage areas or footprints of the beamformed spot beams (e.g., by adjusting the weighting coefficients) so as to track (e.g., move in concert with) the respective mobile terminals (e.g., reference terminals). This may allow communication service associated with a mobile terminal to be provided via a same beamformed spot beam as the mobile terminal moves through the coverage area of the satellite communication system. This may reduce the number of beam-to-beam handoffs of the mobile terminals, which may reduce performance degradation and communication disruptions that can result from beam-to-beam handoffs. For example, a beam-to-beam handoff may require the beam handing off the terminal to coordinate with the beam receiving the terminal, which may require communication spanning several communication layers to transfer terminal information between access points (e.g., gateways, gateway modems) serving the beams and to verify the transfer. This may result in performance degradation and communication disruptions between beams.

Conflicts may occasionally arise between beams as the beams track mobile terminals, such as when two movable beamformed spot beams overlap spatially while using a same resource element (e.g., the same frequency channel, time slot, polarization combination). But these conflicts may be resolved using deconfliction procedures discussed herein. For example, when such a conflict occurs (e.g., based on an interference metric between the beams satisfying a threshold), beam manager 175 may cause one of the conflicting mobile terminals to change to a different resource element. As a result, little or no performance degradation may result. And because the deconfliction may involve only a single beam (e.g., without communication across access points serving different beams), communication disruption associated with handoff between beams may be avoided.

Further, as the reference terminals move, they may remain centrally positioned within the coverage areas of the beams. This may allow the SNR of the reference terminals to remain high so that overall communication speed and efficiency associated with the reference terminals may also be high.

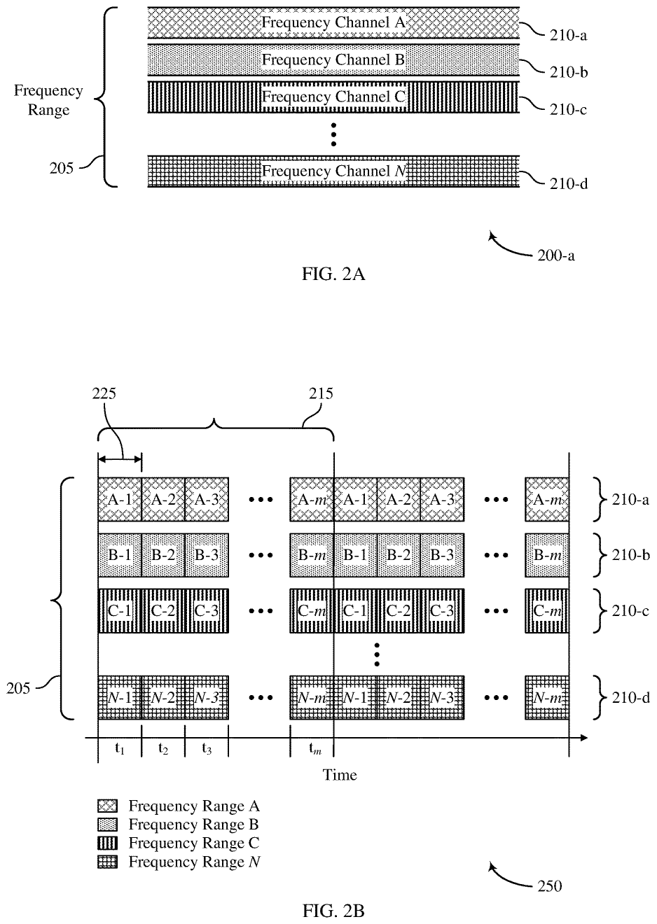

FIG. 2A shows an example of resources 200-a for a satellite communication system that support mobile satellite beam deconfliction in accordance with examples described herein. Resources 200-a may correspond to frequency divisions of a satellite communication system. For example, a frequency range 205 (e.g., a frequency band) may comprise a set of different frequency resources or frequency channels 210 (e.g., frequency channel 210-a, frequency channel 210-b, frequency channel 210-c, frequency channel 210-d) that carry signals between the satellite network and the terminals. The resources 200-a may correspond to the frequency channels 210 of the frequency range 205.

Each frequency channel 210 may carry signals associated with a single terminal (e.g., at a time). For example, each frequency channel 210 may carry a single modulated signal. Information (e.g., data, control information) may be modulated onto the modulated signal using a variety of single-carrier or multi-carrier modulation techniques (e.g., Orthogonal Frequency Division Multiplexing (OFDM), Direct Sequence Spread Spectrum (DSSS), linearly pre-coded OFDM (LP-OFDM)). A beamformed spot beam may be associated with one or more frequency channels 210 (e.g., by beam manager 175), to provide communication to and track mobile terminals as discussed herein.

In the example of FIG. 2A, the resources 200-a may correspond to the frequency channels 210. That is, each frequency channel 210 may be a separate resource 200-a. As there are no other types of resources, the separate resources may also be resource elements in some examples. As such, in this example the number of available resource elements may correspond to the number of frequency channels, N.

FIG. 2B shows an example of resource elements 250 for a satellite communication system that support mobile satellite beam deconfliction in accordance with examples described herein. In this example, frequency channels 210 may again be used to carry signals associated with the terminals. In addition, the frequency channels 210 may be time multiplexed. That is, each frequency channel 210 may be configured to carry signals to the terminals in time slots that repeat after a period of time. For example, a time period 215 may be divided into a set of sub-periods or time slots t (e.g., time slot t₁, time slot t₂, time slot t₃, time slot tₘ) each having a length 225. Each frequency channel 210 may carry a signal to a different terminal during each time slot t, although in some cases multiple time slots within a time period 215 may be allocated to the same terminal. For example, each frequency channel 210 may carry a single modulated signal during each time slot t. Information (e.g., data, control information) may be modulated onto the modulated signal using a variety of single-carrier or multi-carrier modulation techniques (e.g., OFDM, DSSS, LP-OFDM) to provide communication to and track mobile terminals (e.g., by beam manager 175), as discussed herein.

At the completion of the time period 215, the process may repeat such that each frequency channel 210 may carry further signals associated with the different terminals in a resource period. As a result, beam manager 175 may use the frequency channel 210 for communication with the terminal during one time slot t per time period 215. In some examples, beam manager 175 may assign a terminal to more than one time slot per time period, and thus communication with a terminal may occur over more than one time slot per time period for the frequency channel 210.

In the example of FIG. 2B, the resource elements 250 may correspond to the combinations of frequency channels 210 and time slots t in a time period 215. That is, each unique combination of frequency channel 210 and time slot t may be a separate resource element 250. As such, in this example the number of available resource elements may correspond to the number of frequency channels times the number of time slots, or N×m. Thus, this example may provide more resource elements than the example of FIG. 2A.

In addition to being multiplexed in time or frequency, different polarizations may be used to define the resource elements for assignment to beamformed spot beams. For example, a set of resource elements may include a first sub-set of resource elements associated with a first polarization and a second sub-set of resource elements associated with a second, orthogonal, polarization. The first and second polarizations may be orthogonal polarizations, and may be linearly polarized or circularly polarized (e.g., a right-hand circular polarization (RHCP), a left-hand circular polarization (LHCP)). Thus, a set of resource elements available to beam manager 175 for assignment to beamformed spot beams may be defined according to frequency resources (e.g., frequency channels), time resources (e.g., sub-periods of resource periods), or polarization resources.

In some examples, the types of resource elements may be combined. For example, in the same system, one or more frequency channels may be divided into time slots (e.g., as in FIG. 2B) and one or more other frequency channels may be used, undivided (e.g., as in FIG. 2A), as separate resource elements. Other combinations are also possible.

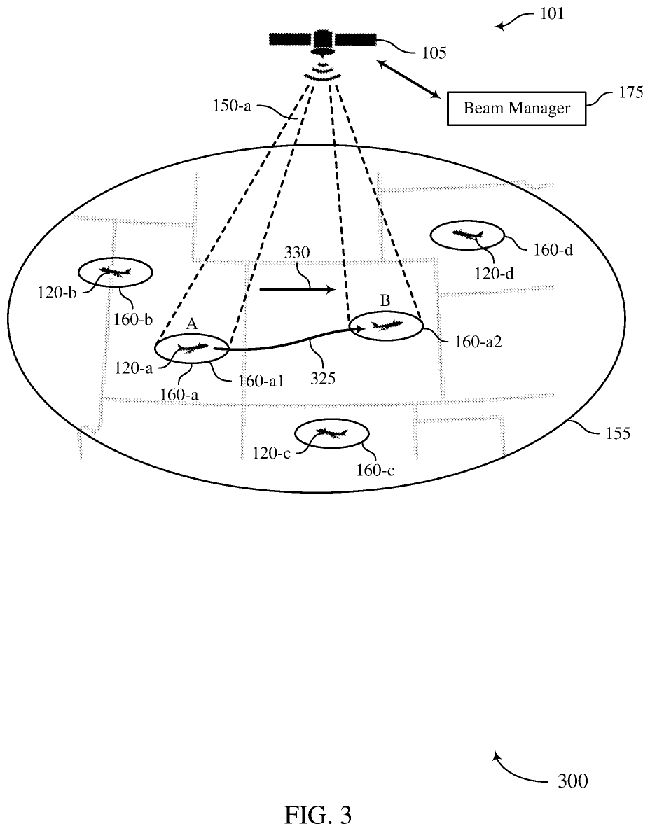

FIG. 3 illustrates an example of a satellite communication system 300 that supports mobile satellite beam deconfliction in accordance with examples as disclosed herein. The satellite communication system 300 may be an example of satellite communication system 100 as described with reference to FIG. 1 or aspects thereof. Satellite communication system 300 may include a satellite network 101 having one or more satellites 105 configured to generate beamformed spot beams 150 (e.g., beam 150-a) for communicating with a set of terminals 120 (e.g., terminals 120-a, 120-b, 120-c, 120-d) within a coverage area 155 of the satellite communication system, as directed by a beam manager 175. Beamformed spot beams may be referred to herein as spot beams or beams.

The terminals 120 may be located on movable platforms or vehicles, such as automobiles, boats, or aircraft, and thus may be considered to be mobile terminals 120. In some examples, each vehicle may include a single mobile terminal. In other examples, one or more vehicles may each include two or more mobile terminals. At least some of mobile terminals 120 may be multi-user mobile terminals, and thus the satellite communication system 300 may provide a communication service to multiple user devices (e.g., smartphones, laptops, tablets) connected via the mobile terminals 120.

In some examples, the satellite communication system 300 may provide communication service to the mobile terminals 120 via a set of movable beamformed spot beams 150 that track the mobile terminals, as controlled by beam manager 175, during movement of the mobile terminals. For the sake of clarity, only a single movable beamformed spot beam 150-a is illustrated in FIG. 3 associated with a single mobile terminal 120-a. Although not illustrated in FIG. 3, movable beamformed spot beams 150 may also be associated with one or more of the other mobile terminals 120.

In some examples, beam manager 175 may associate each beamformed spot beam 150 with a different mobile terminal 120. Each mobile terminal 120 associated with its own spot beam may be referred to as a reference terminal. Each spot beam 150 may have a respective coverage area 160 (e.g., coverage areas 160-a, 160-b, 160-c, 160-d). The coverage area may correspond, for example, to a footprint where the power level of the beam is above a threshold, or where the power level drop-off away from the center of the beam is less than a threshold amount (e.g., 3 dB or 6 dB).

In some examples, a beamformed spot beam associated with a reference terminal may be formed (e.g., as controlled by beam manager 175) to include the terminal's physical location within the coverage area of the beamformed spot beam. For example, as shown in FIG. 3, mobile terminal 120-a, acting as a reference terminal, may be physically located within the coverage area 160-a of beamformed spot beam 150-a and mobile terminals 120-b, 120-c, and 120-d may be physically located within the coverage areas 160-b, 160-c, and 160-d of their respective beamformed spot beams (not shown). The satellite communication system 300 may provide communication service (e.g., via beam manager 175) to mobile terminal 120-a via beamformed spot beam 150-a.

In some examples, beam manager 175 may cause a beamformed spot beam to track a moving mobile terminal while communication service is provided to the terminal via the beam. For example, as mobile terminal 120-a physically moves from location A to location B, as indicated by arrow 325, beamformed spot beam 150-a may “move” so as to track the mobile terminal, as indicated by arrow 330. In some examples, to “move” a beamformed spot beam, beam manager 175 may change and apply the beamforming coefficients associated with the beamformed spot beam to the signal associated with the beamformed spot beam. This may change the directionality of the beamformed spot beam (e.g., “move” the beam) so that the coverage area of the beamformed spot beam changes (e.g., “moves”).

To follow or track a mobile terminal, the beamforming coefficients may be changed by beam manager 175 such that the coverage area of the beamformed spot beam may move to reflect the movement of (e.g., may be moved in concert with) the mobile terminal. Beam manager 175 may continually adjust the coverage area (e.g., by periodically changing the beamforming coefficients to provide continuous coverage) to continue to correspond with the moving physical location of the moving mobile terminal and thereby track the mobile terminal. For example, beam manager 175 may move the coverage area 160-a of beamformed spot beam 150-a (e.g., from coverage area 160-a1 to coverage area 160-a2) so as to encompass the physical location of mobile terminal 120-a as mobile terminal 120-a moves from location A to location B. This may allow communication service associated with the mobile terminal to be provided via the same beamformed spot beam as the mobile terminal moves through the coverage area of the satellite communication system. For example, beam manager 175 may provide continuous communication service to mobile terminal 120-a via beamformed spot beam 150-a without a handoff as the mobile terminal moves between location A and location B.

In some examples, beam manager 175 may refrain from changing the beamforming coefficients associated with a mobile terminal while the mobile terminal is stationary because the coverage area of the beamformed spot beam may already correspond with the physical location of the stationary terminal. In other examples, beam manager 175 may change the beamforming coefficients even when a mobile terminal is stationary. For example, in some systems there may be a set of beamforming coefficients that may generate all of the beams from all of the beam signals. In those cases, even if only one terminal moves, beam manager 175 may change the beamforming coefficients used for all terminals.

In some examples, to track the mobile terminal, beam manager 175 may adjust the coverage area of the spot beam (e.g., move the spot beam) based on measurements of signals communicated with the mobile terminal. In some examples, the terminal may provide channel state information back to the satellite network on a regular and periodic basis, and beam manager 175 may process this channel state information to compute appropriate beamforming coefficients such that the beam energy for the beam signal associated with an aircraft is focused on that aircraft. As the aircraft moves, the channel state information may change, which in turn may induce changes in the beam weight coefficients computed by beam manager 175. Through this beamformer adaptation process, the beam center may be co-located with the aircraft location continuously (may follow the aircraft).

Alternatively, beam manager 175 may use an initial estimate of where to move the beam based on the latest speed and direction of travel of the mobile terminal. In some examples, beam manager 175 may move the spot beam in such a manner that as the mobile terminal moves, the mobile terminal may remain centrally positioned within the coverage area. This may allow the SNR of the mobile terminal to remain high so that overall communication speed and spectral efficiency associated with the mobile terminal may also be high.

In some examples, beam manager 175 may determine the position of the mobile terminal based on information received from the mobile terminal, such as location coordinates (e.g., determined via a positioning system such as GPS), a speed, a direction or other information associated with the mobile terminal. In some examples, beam manager 175 may determine the position of the mobile terminal based on information external to the mobile terminal, such as based on radar or other signals.

In some examples, the satellite communication system may provide the communication service to one or more mobile terminals via beamformed spot beams associated with the terminals. For example, in FIG. 3, beam manager 175 may establish beamformed spot beams 150 for each of mobile terminals 120-a, 120-b, 120-c, and 120-d, and may provide the communication service to the terminals and track the mobile terminals as the mobile terminals move within the coverage area 155 of the satellite communication system.

In some examples, beam manager 175 may use initial channel state information to determine the locations of the mobile terminals. Beam manager 175 may determine the initial channel state information based on measurements (e.g., signal strengths) of initial signals communicated with (e.g., transmitted to or received from) the mobile terminals. The initial channel state information may be based on respective first locations (e.g., location A for mobile terminal 120-a) of the mobile terminals within the coverage area 155. In some examples, the initial signals may include respective initial channel sounding probes communicated with the mobile terminals.

In some examples, to generate the beamformed spot beams, beam manager 175 may apply beamforming coefficients to convert between beam signals associated with each of the beamformed spot beams and component signals associated with a plurality of antenna elements of the satellite communication system. For example, to generate a spot beam for transmitting information to a mobile terminal, beam manager 175 may apply beamforming coefficients to beam signals (that contain the information) to obtain component signals that may be applied to the antenna elements; and to generate a spot beam for receiving information from a mobile terminal, beam manager 175 may apply beamforming coefficients to component signals received from the mobile terminal at the antenna elements to obtain beam signals that contain the information.

The plurality of antenna elements may be positioned on one or more of the satellites 105 or may be positioned on components of a ground network (not shown) of the satellite communication system 300 (e.g., access nodes 140 of ground network 135 as shown in FIG. 1). Beam manager 175 may use the beamforming coefficients to form the beamformed spot beams 150 between the satellites 105 and the coverage areas 160. Beam manager 175 may base the beamforming coefficients on the initial channel state information so that the coverage areas 160 of the beams 150 may encompass the respective first locations (e.g., location A) of the associated terminals 120.

The beamformed spot beams 150 may be forward-link beamformed spot beams (e.g., for transmitting information to the mobile terminals) and/or return-link beamformed spot beams (e.g., for receiving information from the mobile terminals). For example, the beamforming coefficients may include a plurality of sets of forward-link beamforming coefficients and a plurality of sets of return-link beamforming coefficients.

Beam manager 175 may apply a first set of the forward-link beamforming coefficients at a first time to a set of forward-link beam signals to generate a first set of forward-link component signals for transmission to one or more mobile terminals via the antenna elements at the first time. Transmission of the first set of forward-link component signals to the mobile terminals via the antenna elements may form forward-link beamformed spot beams, each corresponding to one of the mobile terminals for the first time.

Beam manager 175 may apply a second set of the forward-link beamforming coefficients at a second time to the set of forward-link beam signals to generate a second set of forward-link component signals for transmission to the mobile terminals via the antenna elements at the second time. Transmission of the second set of forward-link component signals to the mobile terminals via the antenna elements may form the forward-link beamformed spot beams, each corresponding to the mobile terminals for the second time. One or more of the forward-link beamformed spot beams at the second time may have moved from the corresponding forward-link beamformed spot beams at the first time to track movement of corresponding mobile terminals.

On the return link, beam manager 175 may apply a first set of the return-link beamforming coefficients at a first time to return-link component signals received from the mobile terminals via the antenna elements at the first time. Applying the first set of the return-link beamforming coefficients may form return-link beamformed sport beams, each corresponding to one of the mobile terminals, for the first time.

Beam manager 175 may apply a second set of the return-link beamforming coefficients at a second time to return-link component signals received from the mobile terminals via the plurality of antenna elements at the second time. Applying the second set of the return-link beamforming coefficients may form the return-link beamformed spot beams for the second time. One or more of the return-link beamformed spot beams at the second time may have moved from the corresponding return-link beamformed spot beams at the first time to track movement of the corresponding mobile terminals.

In some examples, beam manager 175 may use subsequent channel state information to determine subsequent locations of the mobile terminals. Beam manager 175 may determine the subsequent channel state information based on measurements (e.g., signal strengths) of subsequent signals communicated with the mobile terminals. The subsequent channel state information may be based on respective second locations (e.g., location B for mobile terminal 120-a) of the mobile terminals within the coverage area 155. Differences between the initial channel state information and the subsequent channel state information may be based on movement of the mobile terminals to the respective second locations.

In some examples, the subsequent signals may include respective subsequent channel sounding probes communicated with the mobile terminals. The revisions made to the beamforming coefficients may be based on the respective subsequent channel sounding probes. In some examples, the respective initial and subsequent channel sounding probes may be communicated with the mobile terminals at a first periodicity and the beamforming coefficients may be updated at a second periodicity based thereon.

In some examples, beam manager 175 may revise the beamforming coefficients and apply them to convert between the beam signals and the component signals associated with the plurality of antenna elements of the satellite network. The revised beamforming coefficients may be based on the subsequent channel state information so that the new coverage areas (e.g., coverage area 160-a2) of the beams may encompass the respective second locations (e.g., location B) of the mobile terminals.

The determination of subsequent locations of the mobile terminals and the revisions of the beamforming coefficients based thereon may be repeated by beam manager 175 as often and as long as desired. In this manner, the plurality of beamformed spot beams 150 may track movement of the reference terminals 120 throughout the coverage area 155 of the satellite communication system while communication service is provided to the terminals. In some examples, beam manager 175 may move a beamformed spot beam 150 to track its respective mobile terminal sufficiently often such that the associated coverage area at a current location may overlap the coverage area at the prior location. That is, each movement of the beamformed spot beam 150 may move the beam less than a diameter (e.g., or the radius, or a fraction such as one half of the radius) of the beamformed spot beam 150.

In some examples, the beamforming coefficients (e.g., initial beamforming coefficients and the revised beamforming coefficients) may include sets of beamforming coefficients. Each set of beamforming coefficients may correspond to a different time period for the set of beamformed spot beams. In some examples, the beamforming coefficients may be revised based on a characteristic, attribute, or condition satisfying (e.g., meeting, exceeding, and/or falling below) a threshold. For example, beam manager 175 may revise and apply beamforming coefficients based on a received signal quality (e.g., measured at the reference terminal or at the satellite communication system) falling below a threshold. This may allow the signal quality associated with the mobile terminal to remain high so that overall communication speed and efficiency associated with the mobile terminal may also be high. In some examples, beam manager 175 may determine the received signal quality based on the subsequent channel state information.

In some examples, two or more beams may use different resource elements for providing communication services to the respective mobile terminals. For example, beam manager 175 may cause each beam to use a different resource element (e.g., a different combination of frequency channel, time slot, and polarization) to provide communications to its respective mobile terminal while tracking the mobile terminal. By using different resource elements, interference between the beams may be reduced or eliminated, even when the mobile terminals may be close to each other.

In some examples, two or more beams may use a same resource element for providing communication services to the respective mobile terminals. For example, beam manager 175 may cause two or more beams to use a same combination of frequency channel, time slot, and polarization to provide communications to respective mobile terminals while tracking the mobile terminals. This may be desirable when the mobile terminals are far enough apart so that the respective beams do not interfere with each other. By using the same resource elements, more beams may be used with a particular set of resources, thereby increasing frequency reuse.

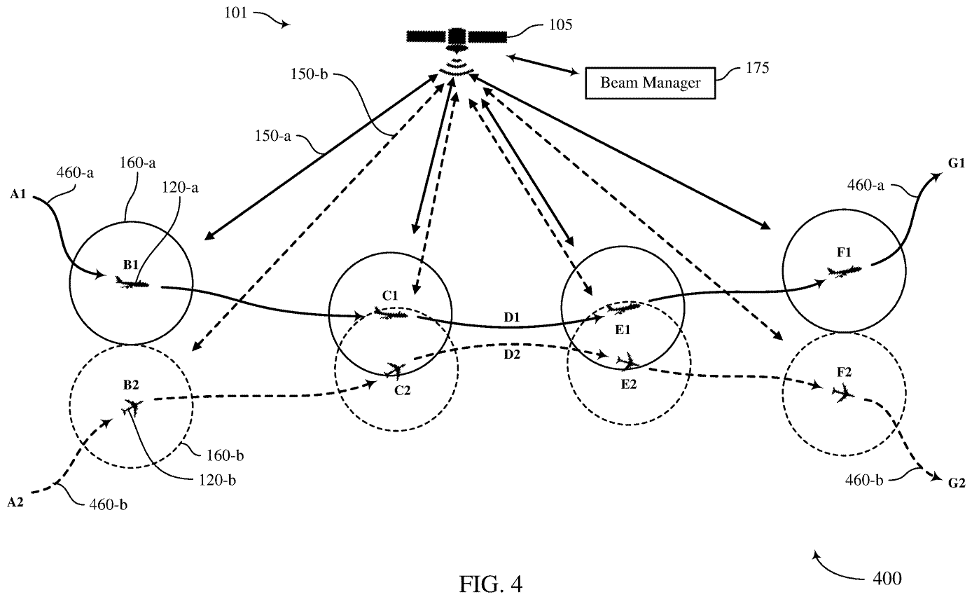

FIG. 4 illustrates another example of a satellite communication system 400 that supports mobile satellite beam deconfliction in accordance with examples as disclosed herein. The satellite communication system 400 may be an example of the satellite communication systems discussed herein, such as satellite communication systems 100 or 300 described with reference to FIG. 1 or FIG. 3 or aspects thereof.

Satellite communication system 400 may include a satellite network 101 having one or more satellites 105 configured to generate movable beamformed spot beams 150 (e.g., beams 150-a and 150-b) for communicating with mobile terminals 120 (e.g., mobile terminals 120-a and 120-b) as the beamformed spot beams track the mobile terminals, as controlled by beam manager 175, discussed herein.

In some examples, each beamformed spot beam 150 may be associated with a different mobile terminal 120. For example, beam manager 175 may associate beamformed spot beam 150-a with mobile terminal 120-a and beamformed spot beam 150-b with mobile terminal 120-b. The beamformed spot beams 150 may have coverage areas 160 (e.g., coverage areas 160-a and 160-b). For the sake of clarity, the moving beamformed spot beam 150-a and associated coverage area 160-a corresponding to moving mobile terminal 120-a are shown in solid lines, and the moving beamformed spot beam 150-b and corresponding coverage area 160-b corresponding to moving mobile terminal 120-b are shown in dashed lines.

FIG. 4 shows an example of two mobile terminals 120-a and 120-b passing close by each other as they travel along respective paths 460-a and 460-b. As with beam 150-b and corresponding coverage area 160-b, the path 460-b corresponding to mobile terminal 120-b is shown in dashed lines. The mobile terminals 120-a and 120-b may travel from respective start locations, represented by A1 and A2, to respective end locations, represented by G1 and G2, along paths 460-a and 460-b. Beams 150-a and 150-b are shown as being on aircraft, although other mobile platforms may also be used. Beams 150-a and 150-b may respectively track mobile terminals 120-a and 120-b (e.g., by beam manager 175 adjusting their respective coverage areas 160-a and 160-b in concert with the movement of the mobile terminals) while communication services are provided to the mobile terminals via the beams as the mobile terminals move along the paths.

As mobile terminals 120 move closer to each other, interference between the associated beams 150 may increase (e.g., when the beams use the same resource element). As discussed herein, beam manager 175 may cause one or both of the beams to switch to a different resource element to ameliorate the interference.

At a point along the paths 460-a and 460-b, represented by B1 and B2, the beams may begin to overlap each other, e.g., by the mobile terminals moving toward each other. As used herein, beams may be considered to be overlapping based on the relative positions of the respective coverage areas of the beams. For example, beams 150-a and 150-b may be overlapping when their respective coverage areas 160-a and 160-b overlap each other. In some cases, the coverage area of a beam may be centered on the position of the mobile terminal that the beam is tracking. For example, coverage areas 160-a and 160-b may be centered on the position of mobile terminals 120-a and 120-b, respectively. In some examples, the overlapping of coverage areas may be based on a distance between the corresponding mobile terminals.

Further along the paths 460-a and 460-b, mobile terminals 120-a and 120-b may arrive at another point, represented by C1 and C2, at which one or more of the mobile terminals may enter into the coverage area of a beam that is not supporting (e.g., not providing communication service to or tracking) the mobile terminal (e.g., by the mobile terminals continuing to move toward each other). For example, at C1/C2, mobile terminal 120-a may enter into coverage area 160-b of beam 150-b, and/or mobile terminal 120-b may enter into coverage area 160-a of beam 150-a. At some point before or after this, interference between beams 150-a and 150-b may rise to an unacceptable level. For example, an interference metric between the beams may satisfy (e.g., meet; or exceed; or meet or exceed) a threshold value. Steps may be taken (e.g., by beam manager 175) to ameliorate the interference (e.g., deconflict the beams), as discussed herein.

The mobile terminals 120-a and 120-b may each remain in the coverage areas 160-a and 160-b of both beams 150-a and 150-b until another point along the paths 460-a and 460-b, represented by E1 and E2. At that point, the mobile terminals may stop being in the coverage areas of the other's beam (e.g., by the mobile terminals moving away from each other). For example, at E1/E2, mobile terminal 120-a may stop being in the coverage area 160-b of beam 150-b and mobile terminal 120-b may stop being in the coverage area 160-a of beam 150-a. Even after the mobile terminals each stop being in the coverage area of the other terminal, the beams may still overlap. For example, at E1/E2, the coverage areas 160-a and 160-b of beams 150-a and 150-b may still overlap.

The beams 150-a and 150-b may remain overlapping until another point along the paths 460-a and 460-b, represented by F1 and F2. At that point, the beams 150-a and 150-b may stop overlapping each other (e.g., by the mobile terminals continuing to move away from each other). From that point to G1/G2 along the paths 460-a and 460-b, the beams 150-a and 150-b may remain apart and not overlapping, as long as the mobile terminals remain far enough apart from each other.

As discussed with respect to FIGS. 2A and 2B, beam manager 175 may use resource elements to provide communication service to mobile terminals via beamformed spot beams. In some examples, if two beams do not conflict (e.g., the interference between the two beams is low), the beams may use a same resource element for providing communication service to the respective mobile terminals. For example, as long as respective interference metrics between beams 150-a and 150-b remain below a threshold value, beam manager 175 may use the same resource element to provide communications to mobile terminals 120-a and 120-b via beams 150-a and 150-b, as discussed herein.

As the mobile terminals 120-a and 120-b move closer to each other (e.g., A1/A2 through B1/B2 and C1/C2 to D1/D2), interference between the corresponding beams 150-a and 150-b may increase. The increase in interference may mean that communication via the separate beams is subject to too much inter-beam interference (e.g., when using the same resource element). When the interference rises to a level (e.g., the interference metric between the beams satisfies a threshold value), steps may be taken by beam manager 175 to deconflict (e.g., ameliorate the interference between) the beams.

In some examples, the interference metric may correspond to a measured interference of one or both of the beams. For example, the interference metric may correspond to a signal strength of a beam associated with a first terminal measured at a second terminal. Additionally, or alternatively, the interference metric may correspond to the degradation of a beam's signal (e.g., a lower SNR) and the threshold may correspond to a specific level of the metric or specific amount of degradation (e.g., 3 dB or 6 dB SNR loss). In some examples, the beam interference may be measured at the receiving device of the communication link. For example, the beam interference may be measured at mobile terminals (for forward links) or satellites (for return links).

In some examples, the interference metric may correspond to a channel correlation. For example, the interference metric may be based on a correlation between channel state information of the two mobile terminals. The interference metric may be frequency dependent.

In some examples, the interference metric may correspond to an estimated interference of one or both of the beams. For example, the estimated interference may be based on the distance between the mobile terminals or on an algorithm that estimates the interference between the associated beams. In some examples, the interference metric may be based on a distance between the mobile terminals associated with the beams and the threshold may correspond to a specific distance. For example, the threshold may correspond to the distance between mobile terminals at which the coverage areas of the corresponding beams begin to overlap (e.g., at B1/B2), or at which one of the mobile terminals enters into the coverage area of the beam corresponding to the other mobile terminal (e.g., at C1/C2), or somewhere in-between. Other distances are also possible.

In some examples, a single beam may be used to provide communication services to more than one mobile terminal. For example, beam manager 175 may assign one of the terminals to be a reference terminal for the beam to track while providing the communication services. A reference terminal may be tasked with providing channel state information to beam manager 175 and may be representative of terminals in the same or similar location. The other terminals may also communicate via the beamformed spot beam that is produced via beamforming coefficients referenced to the reference terminal. This may be accomplished by sharing resources between the mobile terminals. For example, via the same beam, communication service may be provided (e.g., by beam manager 175) to two or more of the mobile terminals on a same frequency channel, but in different time slots corresponding to the mobile terminals. In some examples, the same frequency and time slot may be used for the mobile terminals by further subdividing the time slot (e.g., into MAC layer frames) that may be addressed to the different users.

In some cases, unicast messages may be communicated with two or more mobile terminals via a same beam. For example, a first unicast message may be transmitted to a first mobile terminal and a second unicast message may be transmitted to a second mobile terminal via the same shared beam. In some cases, multicast messages may be communicated with mobile terminals via a same beam. For example, a multicast message may be transmitted to the first and second mobile terminals via a same shared beam. In some cases, unicast messages and multicast messages may be communicated with the mobile terminals via different beams. In other cases, unicast messages and multicast messages may be communicated with the mobile terminals via the same beam. For example, in cases in which communication services are provided to more than one mobile terminal via a single beam (e.g., is shared by the mobile terminals), unicast messages may be communicated via the beam to each of the mobile terminals using different resources (e.g., different time slots) and multicast messages may be communicated via shared resources (e.g., using a shared time slot), or vice versa.

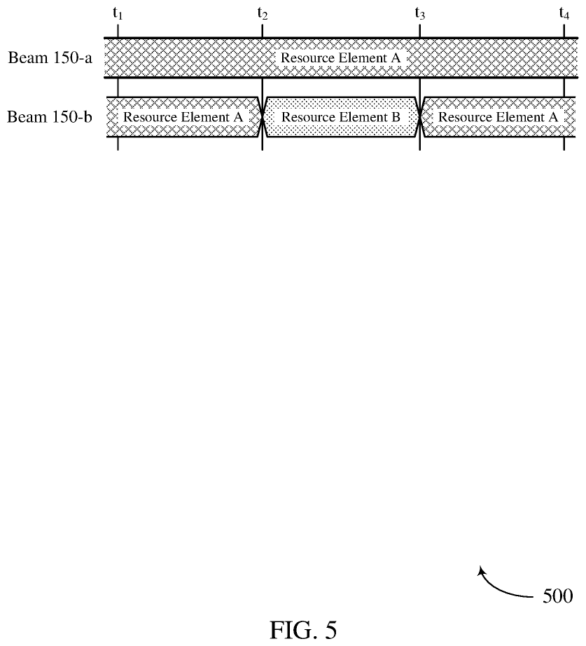

FIG. 5 shows an example timing diagram 500 that supports mobile satellite beam deconfliction in accordance with examples as disclosed herein. Timing diagram 500 represents beams 150-a and 150-b of FIG. 4 that may use different resource elements for providing communication services to mobile terminals 120-a and 120-b when interference rises between the beams. As discussed with respect to FIGS. 3 and 4, a rise in interference may occur, e.g., when the mobile terminals get close to each other while the same resource element is being used by the corresponding beams. As shown in timing diagram 500, one of the beams (e.g., beam 150-b) may be switched to a different resource element (e.g., by beam manager 175) to ameliorate the interference.

Beams 150-a and 150-b may both be originally assigned (e.g., by beam manager 175) to a same resource element A at or before start time t₁, which may correspond to mobile terminals 120-a and 120-b being at A1/A2. As such, the satellite communication system may provide communication service to mobile terminals 120-a and 120-b via beams 150-a and 150-b using the same resource element A at start time t₁.

The mobile terminals may be a substantial distance from each other at start time t₁, such that beams 150-a and 150-b do not conflict with each other (e.g., there may be little, if any, interference between the beams, even though they are assigned to the same resource element A). As such, an interference metric between the beams may be relatively low (e.g., below a threshold value). Beams 150-a and 150-b may be semi-statically assigned to the same resource element A (e.g., by beam manager 175), such that each terminal monitors the same resource element and/or transmits over the same resource element until the terminal receives an indication to switch its resource element.

At time t₂, the interference between the beams may rise to an unacceptable level (e.g., the interference metric may satisfy a first threshold value). In some examples, this may correspond to when one of mobile terminals 120 enters into the coverage area of the other beam 150 (e.g., at or near C1/C2). In some examples, this may correspond to mobile terminals 120 being between B1/B2 and C1/C2. Other locations may also be possible, based on when the interference metric value satisfies the first threshold value. Some potential interference metrics and thresholds are discussed with respect to FIG. 4.

To ameliorate the interference, one of the beams may be changed to a different resource element (e.g., by beam manager 175). For example, at time t₂, in response to the interference metric satisfying the first threshold value, beam manager 175 may cause beam 150-b to switch resource elements (e.g., by reassigning beam 150-b to a resource element B that is different than resource element A) for providing communication service to mobile terminal 120-b. This may include changing one or more of the frequency, time slot, polarization, or other resource (e.g., one or more codes) associated with beam 150-b to be different than that used by beam 150-a. In some examples, resource element B may be orthogonal to resource element A.

Because communication service may be provided to the mobile terminals 120-a and 120-b via beams 150-a and 150-b using different resource elements after time t₂, the interference between beams 150-a and 150-b may be greatly reduced or no longer present. Thus, the satellite communication system may continue to provide communication service to mobile terminal 120-b without a beam-to-beam handoff being performed.

At time t₃, beams 150-a and 150-b may again use a same resource element as each other. For example, at time t₃, beam 150-b may revert back to the original resource element (e.g., by beam manager 175 reassigning beam 150-b back to resource element A) for providing communication service to mobile terminal 120-b. Alternatively, beams 150-a and 150-b may continue to use different resource elements than each other. For example, instead of changing the resource element of beam 150-b back to resource element A, beam manager 175 may cause beam 150-b to continue using resource element B after t₃.

Time t₃ may correspond to when an interference or a potential interference between the beams may no longer be at an unacceptable level (e.g., an interference metric may not meet or exceed a second threshold value or may fall below a second threshold value). The interference metric may or may not be the same interference metric used at time t₂. Further, if the interference metric is the same as that used at time t₂, the second threshold value may be the same or different than the first threshold value used at time t₂. In some cases, time t₃ may correspond to when the mobile terminals are a certain distance from each other. Some potential interference metrics and thresholds are discussed with respect to FIG. 4.

After time t₃, as long as the interference metric between the beams remains below a threshold value (e.g., the first threshold value or the second threshold value), the satellite communication system may continue providing communication service to the mobile terminals via beams 150-a and 150-b using the same resource element (e.g., resource element A) until at least time t₄. Time t₄ may correspond to mobile terminals 120-a and 120-b being at G1/G2. If, however, the interference between the beams again rises to the level (e.g., the interference metric again satisfies the first threshold value), beam manager 175 may again cause one of the beams (e.g., beam 150-b) to switch to a different resource element than the other beam and, in some examples, back again. This switching may be performed each time the interference between the beams rises to the level. As a result, beam-to-beam handoffs may be avoided.

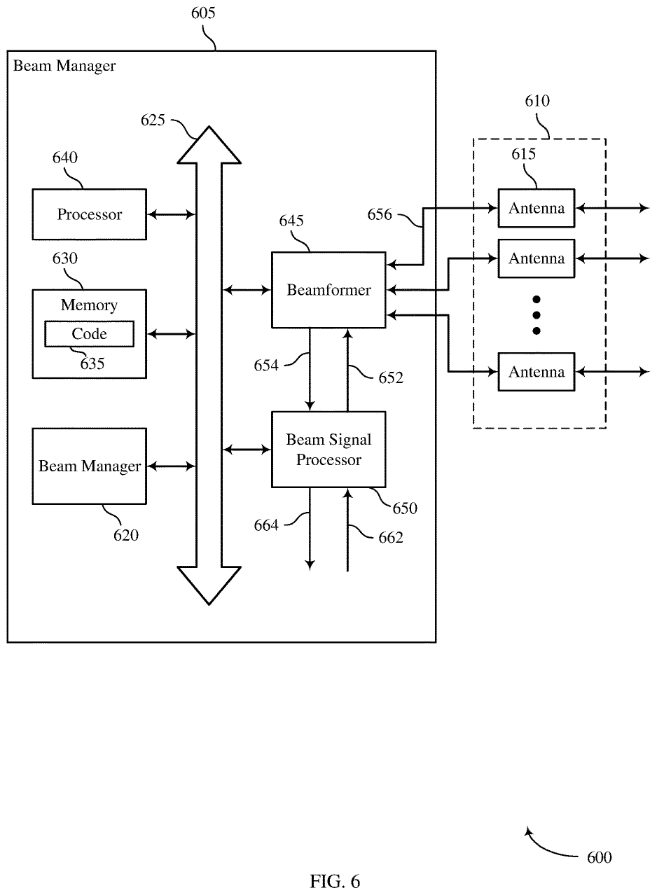

FIG. 6 shows a block diagram 600 of a beam manager 605 that supports mobile satellite beam deconfliction in accordance with examples as disclosed herein. Beam manager 605 may be an example of beam manager 175 of FIG. 1. Beam manager 605 may include a bus 625, a terminal tracker 620, a memory 630, code 635, a processor 640, a beamformer 645, and a beam signal processor 650, and may be configured to control beam tracking of mobile terminals and deconfliction of the beams via an antenna array 610.

Beam manager 605 may be located within the ground network (e.g., ground network 135 of FIG. 1) or the satellite network (e.g., satellite network 101 of FIG. 1) of the satellite communications system. Alternatively, beam manager 605 may be divided between the ground network and the satellite network. In one example (e.g., corresponding to a GBBF configuration), all of the components of beam manager 605 may be located in the ground network. In another example (e.g., corresponding to an OBBF configuration), the beamformer 645 may be located in the satellite network (e.g., in one or more of the satellites) and the rest of the components of beam manager 605 may each be located in either the ground network or the satellite network.

Antenna array 610 may be an example of the antennas of the satellite network 101 of FIG. 1 and may include antenna elements 615. In some examples, one or more of the antenna elements 615 may be or include an antenna panel. The spacing between antenna elements 615 may be evenly distributed across an aperture of antenna array 610, or the spacing of antenna elements 615 may be different across antenna array 610. In some examples, a first antenna array 610 may be included within the ground segment and a second antenna array 610 (e.g., one or more antenna arrays coupled with each other using transponders) may be included within the space segment.

Bus 625 may represent an interface over which signals may be exchanged between components of beam manager 605 and a location (e.g., a central location) that may be used to distribute the signals to the signal processing components of beam manager 605 (e.g., terminal tracker 620, beam signal processor 650, beamformer 645). Bus 625 may include one or more wired interfaces. Additionally, or alternatively, bus 625 may be a wireless interface that is used to wirelessly communicate signaling between the signal processing components—e.g., in accordance with a communication protocol. Beamformer 645 may be coupled with antenna elements 615 via one or more wired or wireless interfaces.

The memory 630 may include volatile memory (e.g., random access memory (RAM)) and/or non-volatile memory (e.g., read-only memory (ROM)). Other types of memory may also be possible. The memory 630 may store code 635 that is computer-readable and computer-executable. The code may include instructions that, when executed by processor 640, cause beam manager 605 to perform various functions described herein. The code 635 may be stored in a non-transitory computer-readable medium such as system memory or another type of memory. In some cases, the code 635 may not be directly executable by processor 640 but may cause a computer (e.g., when compiled and executed) to perform functions described herein. In some cases, the memory 630 may contain, among other things, a basic I/O system (BIOS) which may control basic hardware or software operation such as the interaction with peripheral components or devices.

Processor 640 may include an intelligent hardware device (e.g., a general-purpose processor), a digital signal processor (DSP), a central processing unit (CPU), a microcontroller, an application-specific integrated circuit (ASIC), a field programmable gate array (FPGA), a programmable logic device (PLD), a discrete gate or transistor logic component, a discrete hardware component, or any combination thereof. Processor 640 may be configured to execute computer-readable instructions stored in a memory (e.g., memory 630) to cause beam manager 605 to perform various functions (e.g., functions or tasks supporting mobile satellite beam deconfliction). For example, processor 640 and memory 630 may be configured to perform the various functions described herein.

Beam signal processor 650 may be configured to process (e.g., demodulate, decode) receive beam signals 654 received from beamformer 645. Beam signal processor 650 may decode data symbols included in the receive beam signals 654 to obtain receive beam data signals 664. Information (e.g., packets) in receive beam data signals 664 may be passed (e.g., via network(s) 125) to a destination device. Beam signal processor 650 may also be configured to process (e.g., encode, modulate) transmit beam data signals 662 to obtain transmit beam signals 652 to send to beamformer 645. Transmit beam data signals 662 may include information (e.g., packets) received (e.g., via network(s) 125) for transmission to terminals 120.

Terminal tracker 620 may be configured to determine information for beamformer 645 to use in forming beamformed spot beams (e.g., beamformed spot beams 150 of FIG. 1) using antenna elements 615. To determine the information for forming the beamformed spot beams, terminal tracker 620 may identify a set of terminals (e.g., mobile terminals 120 of FIG. 1) to be assigned as reference terminals, and may determine spatial information associated with the reference terminals. Terminal tracker 620 may determine a set of beamforming coefficients (e.g., phase shifts, amplitude components) that beamformer 645 may use to generate beamformed spot beams having individual coverage areas directed to the spatial information associated with the reference terminals.

Terminal tracker 620 may determine the beamforming coefficients to isolate signals transmitted over beamformed spot beams from one another—e.g., by, in each beamformed spot beam, emphasizing the signals transmitted within the beamformed spot beam and canceling interference from signals transmitted within other beamformed spot beams. The beamforming coefficients may be included in an M×N matrix, where a value of M may indicate the quantity of antennas and a value of N may indicate the quantity of spatial layers, where the value of N may be less than or equal to the value of M.

For transmission of beamformed spot beams via antenna elements 615, terminal tracker 620 may determine a single set of transmit beamforming coefficients for a frequency range or channel (e.g., a frequency channel 210 of FIG. 2B) and each of one or more time periods (e.g., time periods 215, time slots t of FIG. 2B), that is applied to a set of transmit beam signals 652 associated with the beamformed spot beams. Beamformer 645 may apply the set of transmit beamforming coefficients to the set of transmit beam signals 652 to obtain component signals 656 for transmission via antenna elements 615.

For reception of beamformed spot beams via antenna elements 615, terminal tracker 620 may determine a single set of receive beamforming coefficients for a frequency range or channel (e.g., a frequency channel 210 of FIG. 2B) and each of one or more time periods (e.g., time periods 215, time slots t of FIG. 2B), that may be applied to component signals 656 by beamformer 645 to obtain a set of receive beam signals 654 associated with the beamformed spot beams.

In some examples, the beamforming coefficients may be determined at the one or more satellites 105. In some examples, the beamforming coefficients may be received by the one or more satellites from one or more ground stations (e.g., network devices 130 or other stations of ground network 135) after terminal tracker 620 determines the beamforming coefficients.

In some examples, terminal tracker 620, beamformer 645, beam signal processor 650, or various combinations or components thereof, may be implemented in hardware (e.g., in communications management circuitry). The hardware may include a processor, a DSP, an ASIC, an FPGA or other PLD, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, terminal tracker 620, beamformer 645, beam signal processor 650, or various combinations or components thereof, may be implemented in code 635 (e.g., as communications management software or firmware), executed by processor 640. If implemented in code 635 executed by processor 640, the functions of terminal tracker 620, beamformer 645, beam signal processor 650, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

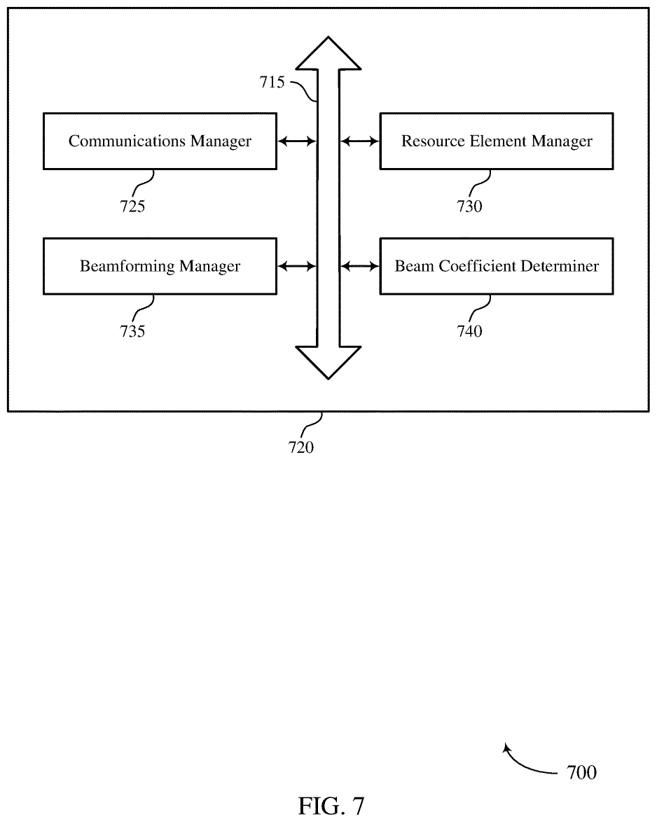

FIG. 7 shows a block diagram 700 of a terminal tracker 720 that supports mobile satellite beam deconfliction in accordance with examples as disclosed herein. Terminal tracker 720 may be an example of aspects of terminal tracker 620 as described with reference to FIG. 6. Terminal tracker 720, or various components thereof, may be an example of means for performing various aspects of mobile satellite beam deconfliction as described herein. For example, terminal tracker 720 may include a communications manager 725, a resource element manager 730, a beamforming manager 735, a beam coefficient determiner 740, or any combination thereof. Each of these components may communicate, directly or indirectly, with one another (e.g., via one or more buses 715).

The communications manager 725 may be configured as or otherwise support a means for providing a communication service to a plurality of mobile terminals via a set of beamformed spot beams. In some examples, the communications manager 725 may be configured as or otherwise support a means for providing a communication service to a first mobile terminal and a second mobile terminal via a first beamformed spot beam and a second beamformed spot beam of a satellite communication system, as discussed herein. The first and second mobile terminals may be respectively assigned to the first and second beamformed spot beams. In some examples, the communications manager 725 may comprise one or more of the other components of terminal tracker 720. In some examples, the communications manager 725 may comprise the resource element manager 730, the beamforming manager 735, and the beam coefficient determiner 740.

The resource element manager 730 may be configured as or otherwise support a means for assigning the first and second beamformed spot beams to a same first resource element, as discussed herein. The resource element manager 730 may also be configured as or otherwise support a means for reassigning the second beamformed spot beam to a second resource element that is different than the first resource element. The reassigning may be based on adjusting the respective coverage areas of the first and second beamformed spot beams, and on an interference metric between the first and second beamformed spot beams satisfying a threshold value.

The beamforming manager 735 may be configured as or otherwise support a means for applying beamforming coefficients to convert between beam signals associated with the set of beamformed spot beams and component signals associated with a plurality of antenna elements positioned on one or more satellites of the satellite communication system, as discussed herein. The beamforming manager 735 may also be configured as or otherwise support a means for adjusting respective coverage areas of the first and second beamformed spot beams to track movement of the first and second mobile terminals within a coverage area of the satellite communication system, as discussed herein.

In some examples, the beam coefficient determiner 740 may be configured as or otherwise support a means for determining the beamforming coefficients before applying the beamforming coefficients to component signals.

In some examples, aspects of one or more components of terminal tracker 620 or 720 may be found in other components of the terminal tracker or even outside of the terminal tracker. For example, processor 640 and memory 630 may be used in performing one or more functions associated with the components of terminal tracker 720.

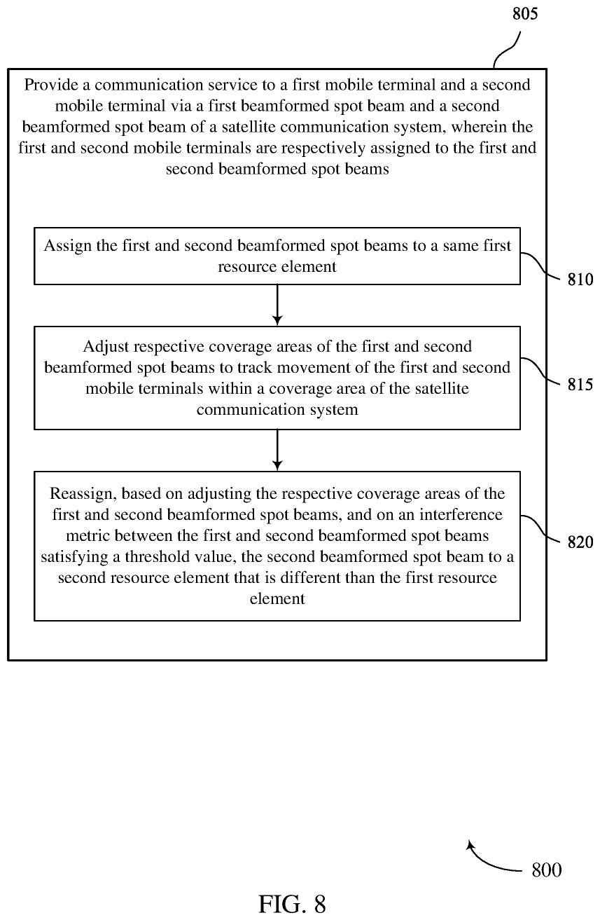

FIG. 8 shows a flowchart illustrating a method 800 that supports mobile satellite beam deconfliction in accordance with examples as disclosed herein. The operations of method 800 may be implemented by a satellite communication system or its components as described herein. For example, the operations of method 800 may be performed by a beam manager as described with reference to FIGS. 1 through 7. In some examples, a processor may execute a set of instructions to control the functional elements of the beam manager to perform the described functions. Additionally, or alternatively, the beam manager may perform aspects of the described functions using special-purpose hardware.

At 805, the method may include providing a communication service to a first mobile terminal and a second mobile terminal via a first beamformed spot beam and a second beamformed spot beam of a satellite communication system, wherein the first and second mobile terminals are respectively assigned to the first and second beamformed spot beams. The operations of 805 may be performed in accordance with examples as disclosed herein. In some examples, aspects of the operations of 805 may be performed by a communications manager 725 as described with reference to FIG. 7. In some examples, providing the communication service may include the operations of 810, 815, and 820.

At 810, the method may include assigning the first and second beamformed spot beams to a same first resource element. The operations of 810 may be performed in accordance with examples as disclosed herein. In some examples, aspects of the operations of 810 may be performed by a resource element manager 730 as described with reference to FIG. 7.

At 815, the method may include adjusting respective coverage areas of the first and second beamformed spot beams to track movement of the first and second mobile terminals within a coverage area of the satellite communication system. The operations of 815 may be performed in accordance with examples as disclosed herein. In some examples, aspects of the operations of 815 may be performed by a beamforming manager 735 as described with reference to FIG. 7.

At 820, the method may include reassigning, based on adjusting the respective coverage areas of the first and second beamformed spot beams, and on an interference metric between the first and second beamformed spot beams satisfying a threshold value, the second beamformed spot beam to a second resource element that is different than the first resource element. The operations of 820 may be performed in accordance with examples as disclosed herein. In some examples, aspects of the operations of 820 may be performed by a resource element manager 730 as described with reference to FIG. 7.

In some examples, an apparatus as described herein may perform a method or methods, such as method 800. The apparatus may include features, circuitry, logic, means, or instructions (e.g., a non-transitory computer-readable medium storing instructions executable by a processor), or any combination thereof for performing the method or methods.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
providing a communication service to a first mobile terminal and a second mobile terminal via a first beamformed spot beam and a second beamformed spot beam of a satellite communication system wherein the first and second mobile terminals are respectively assigned to the first and second beamformed spot beams, wherein the first and second beamformed spot beam are respectively associated with first beamforming weights and second beamforming weights, and wherein providing the communication service comprises:
assigning, based at least in part on an interference metric between the first and second beamformed spot beams failing to satisfy a threshold value, the first and second beamformed spot beams to a same first resource element of a set of resource elements, wherein each resource element in the set of resource elements comprises time resources, frequency resources, and polarization resources, and wherein the first resource element comprises first time resources, first frequency resources, and first polarization resources;
adjusting, through adjustment of the first beamforming weights and the second beamforming weights, respective coverage areas of the first and second beamformed spot beams such that the first and second beamformed spot beams track movement of the first and second mobile terminals within a coverage area of the satellite communication system; and
reassigning, based at least in part on adjusting the respective coverage areas of the first and second beamformed spot beams and on the interference metric between the first and second beamformed spot beams satisfying the threshold value, the second beamformed spot beam to a second resource element of the set of resource elements that is different than the first resource element due to second time resources of the second resource element that at least partially differ from the first time resources of the first resource element, second frequency resources of the second resource element that at least partially differ from the first frequency resources of the first resource element, second polarization resources of the second resource element that at least partially differ from the first polarization resources of the first resource element, or any combination thereof, wherein the interference metric is based on one or more of a measured interference between the first and second beamformed spot beams, an estimated interference between the first and second beamformed spot beams, a correlation between channels of the first and second mobile terminals, or a distance between the first and second mobile terminals.

2. (canceled)

3. The method of claim 1, wherein providing the communication service further comprises:
reassigning, after reassigning the second beamformed spot beam to the second resource element and based on adjusting the respective coverage areas of the first and second beamformed spot beams, and based on the interference metric between the first and second beamformed spot beams satisfying a second threshold value, the second beamformed spot beam back to the first resource element.

4. The method of claim 3, wherein the second threshold value equals the threshold value.

5. The method of claim 1, wherein providing the communication service further comprises:
maintaining the assignment of the first beamformed spot beam to the first resource element after reassigning the second beamformed spot beam to the second resource element.

6. A method, comprising:
providing a communication service to a first mobile terminal and a second mobile terminal via a first beamformed spot beam and a second beamformed spot beam of a satellite communication system, wherein the first and second mobile terminals are respectively assigned to the first and second beamformed spot beams, wherein providing the communication service comprises:
assigning the first and second beamformed spot beams to a same first resource element;
adjusting respective coverage areas of the first and second beamformed spot beams to track movement of the first and second mobile terminals within a coverage area of the satellite communication system; and
reassigning, based on adjusting the respective coverage areas of the first and second beamformed spot beams, and on an interference metric between the first and second beamformed spot beams satisfying a threshold value, the second beamformed spot beam to a second resource element that is different than the first resource element, wherein the threshold value is based on respective beam widths of the first and second beamformed spot beams.

7. The method of claim 1, wherein reassigning the second beamformed spot beam to the second resource element comprises:
changing the respective resource element of the second beamformed spot beam to be orthogonal to the first resource element.

8. The method of claim 7, wherein changing the second resource element to be orthogonal to the first resource element comprises:
changing at least one of a frequency of the second beamformed spot beam, a time slot assigned to the second beamformed spot beam, a polarization assigned to the second beamformed spot beam, or one or more codes assigned to the second beamformed spot beam.

9. The method of claim 1, wherein adjusting the respective coverage areas of the first and second beamformed spot beams is based on measurements of signals communicated with the first and second mobile terminals.

10. The method of claim 1, wherein providing the communication service further comprises:
applying beamforming coefficients to component signals associated with a plurality of antenna elements of the satellite communication system.

11. The method of claim 10, wherein providing the communication service further comprises:
receiving the beamforming coefficients from one or more ground stations before applying the beamforming coefficients to the component signals.

12. The method of claim 10, wherein adjusting the respective coverage areas of the first and second beamformed spot beams comprises:
adjusting the beamforming coefficients to move the respective coverage areas of the first and second beamformed spot beams to reflect the movement of the first and second mobile terminals.

13. The method of claim 12, wherein providing the communication service further comprises:
receiving the beamforming coefficients from one or more ground stations, wherein adjusting the beamforming coefficients comprises applying the adjusted beamforming coefficients to the component signals.

14. The method of claim 1, wherein the first and second resource elements each comprises a frequency and a time slot.

15. The method of claim 1, wherein the first and second resource elements each comprises a polarization.

16-58. (canceled)
